(19) United States
(12) Patent Application Publication
(10) Pub. No.: US 2014/0010678 A1
(43) Pub. Date: Jan. 9, 2014

(54) AUTOMOTIVE FLUIDIC PUMP

(71) Applicants: Nicola Novi, Pisa (IT); Giacomo Armenio, Livorno (IT)

(72) Inventors: Nicola Novi, Pisa (IT); Giacomo Armenio, Livorno (IT)

(73) Assignee: PIERBURG PUMP TECHNOLOGY GMBH, NEUSS (DE)

(21) Appl. No.: 13/979,850

(22) PCT Filed: Jan. 18, 2012
(86) PCT No.: PCT/EP2012/050675

§ 371 Date: Sep. 25, 2013

(30) Foreign Application Priority Data
Jan. 18, 2011 (EP) 11425010.3

(51) Int. Cl. F16D 37/02

(52) U.S. Cl. CPC F16D 37/02
USPC 417/223; 417/319

(57) ABSTRACT

An automotive fluidic pump includes a driving device, a pump wheel, a hydraulic coupling configured as a magneto-rheological coupling comprising a rotatable driving clutch element which is permanently connected to the driving device. A rotatable driven clutch element is permanently connected to the pump wheel. A magneto-rheological liquid filling a working gap is arranged between the rotatable driven clutch element and the rotatable driving clutch element. A magnetic unit comprises a permanent magnet and an electromagnet. The permanent magnet and the electromagnet are each configured to magnetically affect the working gap. Each of the driving device and the pump wheel are connectable by the hydraulic coupling. The electromagnet is arranged to compensate a magnetic field created by the permanent magnet in the working gap when the electromagnet is activated.

### CROSS REFERENCE TO PRIOR APPLICATIONS

This application is a U.S. National Phase application under 35 U.S.C. §371 of International Application No. PCT/EP2012/050675, filed on Jan. 18, 2012 and which claims benefit to European Patent Application No. 11425010.3, filed on Jan. 18, 2011. The International Application was published in English on Jul. 26, 2012 as WO 2012/098137 Al under PCT Article 21(2).

### FIELD

The present invention relates to a mechanical automotive fluidic pump which is directly mechanically driven by an internal combustion engine. The fluidic pump can be a pneumatic pump or a liquid pump.

### BACKGROUND

A mechanical automotive fluidic pump is directly driven by the combustion engine so that the rotational frequency of the pump is proportional to the rotational frequency of the engine. For an improved adaptation of the pumping performance to the pumping performance demand, the pump is provided with a coupling. The pumping performance of the pump is adapted by engaging and disengaging the coupling, thereby connecting and disconnecting the pump wheel with/from an actuated driving means which can be a belt pulley driven by the engine.

U.S. 2005/0188690 A1 and U.S. Pat. No. 7,422,093 B2 describe a coupling for an automotive hydraulic power steering pump which is realized in the form of a magneto-rheological coupling. The coupling is provided with a driven clutch element being permanently connected to the pump wheel, with a driving clutch element being permanently connected to the pulley wheel, and with a magneto-rheological liquid filling a working gap between the two clutch elements. The coupling is engaged or connected by activating an electromagnet so that the magnetic field generated by the electromagnet penetrates the working gap so that the magnetic field immediately causes an increased viscosity of the magneto-rheological liquid. If the electromagnet fails, the coupling cannot be engaged or connected. This arrangement is not failsafe, so that it is not suitable for pumps with essential functions.

### SUMMARY

An object of the present invention is to provide a failsafe mechanical automotive fluidic pump.

In an embodiment, the present invention provides an automotive fluidic pump which includes a driving device, a pump wheel, a hydraulic coupling configured as a magneto-rheological coupling comprising a rotatable driving clutch element which is permanently connected to the driving device. A rotatable driven clutch element is permanently connected to the pump wheel. A magneto-rheological liquid filling a working gap is arranged between the rotatable driven clutch element and the rotatable driving clutch element. A magnetic unit comprises a permanent magnet and an electromagnet. The permanent magnet and the electromagnet are each configured to magnetically affect the working gap. Each of the driving device and the pump wheel are connectable by the hydraulic coupling. The electromagnet is arranged to compensate a magnetic field created by the permanent magnet in the working gap when the electromagnet is activated.

### BRIEF DESCRIPTION OF THE DRAWINGS

The present invention is described in greater detail below on the basis of embodiments and of the drawings in which:

FIG. 1 shows the longitudinal section of a mechanical pneumatic pump; and

FIG. 2 shows a longitudinal section of a mechanical automotive coolant pump.

### DETAILED DESCRIPTION

The mechanical automotive fluidic pump according to the present invention is provided with a magneto-rheological coupling which is provided with a permanent magnet magnetically affecting the working gap and also with an electromagnet magnetically affecting the working gap. When the electromagnet is not activated, only the permanent magnet affects the magneto-rheological liquid in the working gap so that the viscosity of the liquid is high and the coupling is engaged or connected. When the electromagnet is activated, i.e., electrically energized, the magnetic field generated by the permanent magnet affecting the working gap is significantly compensated so that the resulting magnetic field is decreased significantly. This decreased magnetic field in the working gap has the effect that the viscosity of the magneto-rheological liquid is significantly decreased, so that the coupling is more or less disconnected.

If the electromagnet fails, the coupling will always be engaged or connected so that the coupling of the pump and the pump itself are failsafe. This failsafe arrangement of a magneto-rheological coupling is generally applicable for many other applications of a magneto-rheological coupling and is principally not limited to a pump.

In an embodiment of the present invention, the fluidic pump can, for example, be a coolant pump and the driving means can, for example, be a pulley wheel driven by an internal combustion engine via a transmission belt. The functionality of a coolant pump pumping a coolant for cooling an internal combustion engine is significant for the life of the internal combustion engine so that the coolant pump must not fail, even if electric or electronic problems occur. The fail safe pump is therefore suitable for an application as a coolant pump.

In an embodiment of the present invention, a pump control means can, for example, be provided which activates the electromagnet as long as the engine's temperature is below a limiting value. When the engine is cold, the pumping performance of the coolant pump is reduced to a minimum by activating the electromagnet. When the coolant temperature is increasing and is higher than the limiting value, the electromagnet is switched off so that the magneto-rheological liquid's viscosity is increased and the clutch is engaged.

In an embodiment of the present invention, the magnetic arrangement with the electromagnet and/or the permanent magnet can, for example, be arranged so as to be non-rotating and to be a stationary part of the pump. The electromagnet and the permanent magnet can be fixedly connected to the pump frame. The static arrangement of the electromagnet makes it easier to electrically connect the electromagnet with a non-rotating control means.

In an embodiment of the present invention, the permanent magnet can, for example, be a magnet ring and the electromagnet can, for example, be a ring coil which is surrounded by a toroidal or, in cross-section, a U-shaped back iron with the opening radially outwardly. The magnetizing of the permanent ring magnet is in-line with the back iron so that the magnetic field of the permanent magnet is parallel with and overlaps the magnetic field of the activated electromagnet. The permanent magnet is magnetized in-line with the orientation of the activated electromagnet's magnetic field penetrating the permanent magnet.

The permanent magnet can be arranged radially adjacent to the electromagnet ring coil. In this case, the permanent magnet is magnetized axially.

Two embodiments of the present invention are described with reference to the drawings.

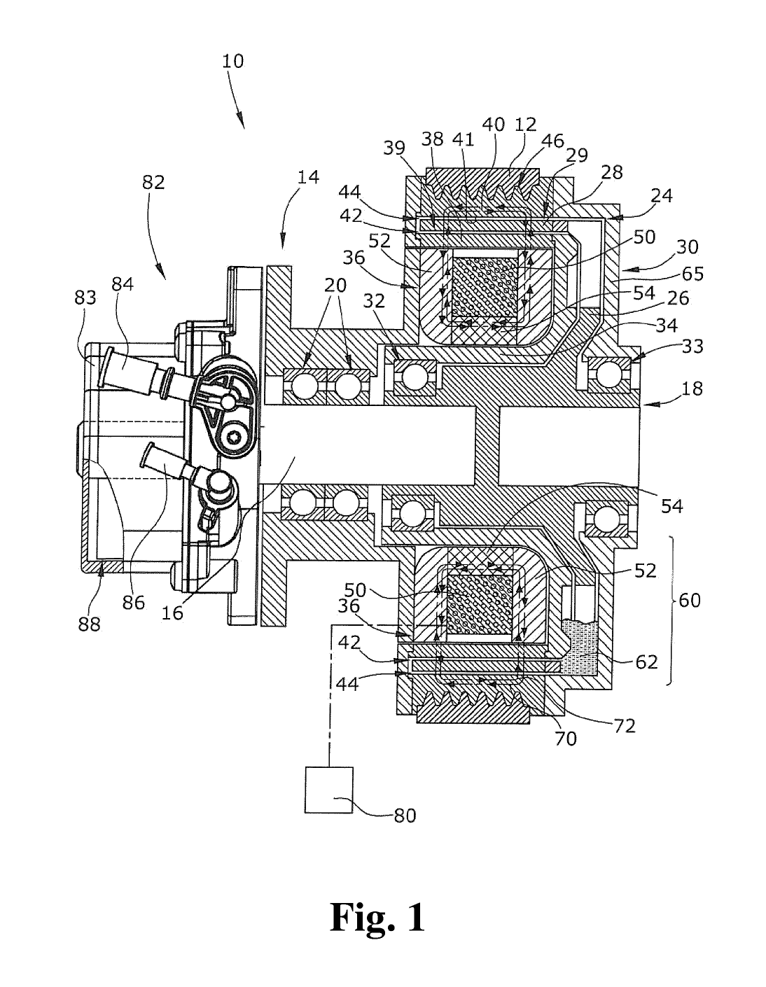

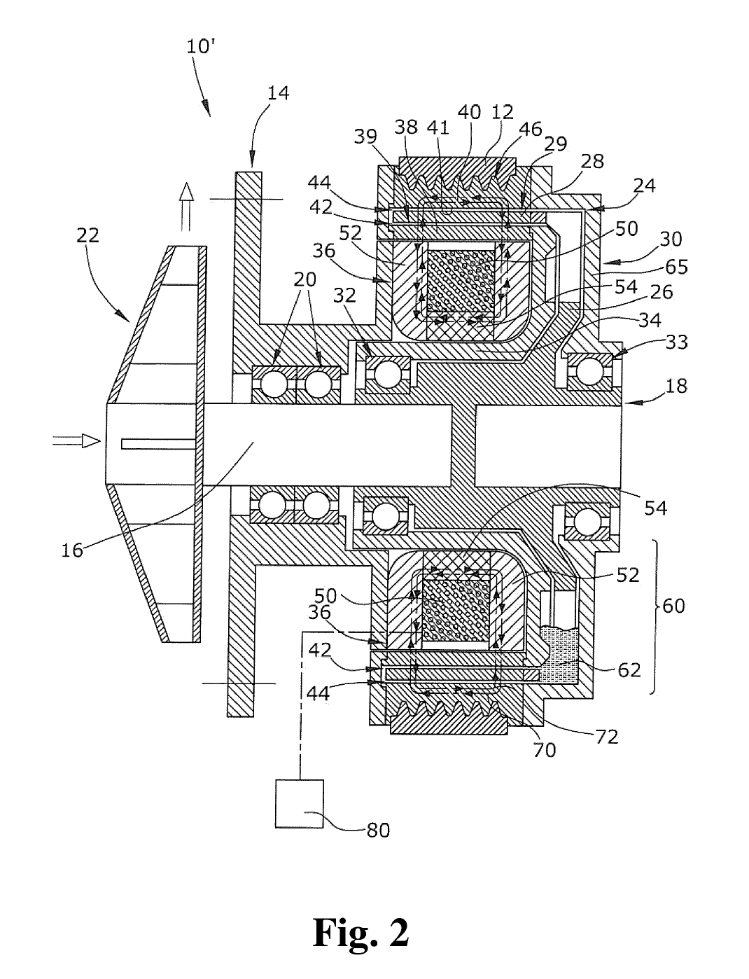

FIG. 1 shows a mechanical automotive pneumatic pump 10 and FIG. 2 shows a mechanical automotive fluidic pump 10′ in the form of a coolant pump. Both pumps 10;10′ are fluid pumps. The pneumatic pump 10 provides a gas, for example air, under pressure, or provides vacuum to other engine's components. The coolant pump 10′ provides a liquid coolant to an internal combustion engine. The pumps 10;10′ are directly driven by the engine via a transmission belt 12.

Both pumps 10 comprise a pump frame 14;14′ which can be mounted to an engine block of the engine (not shown). The pump frame 14;14′ supports a rotor shaft 16 of a pump rotor 18 by means of two roller bearings 20. The pump rotor 18 consists of a pump wheel 88/an impeller pump wheel 22, the rotor shaft 16, and a rotatable clutch part 24 which is permanently connected to the pump wheel 22 by the rotor shaft 16.

The pneumatic pump 10 is provided with a pump section 82 which comprises the pump housing 83, a pump inlet 84, a pump outlet 86, and a pump wheel 88 inside the pump housing 83. The coolant pump 10′ is provided with impeller pump wheel 22. The housing enclosing of the impeller pump wheel 22 is defined by a respective opening in an engine block (not shown).

The pump rotor 18, and in particular the rotatable clutch part 24 is provided with a cylindrical clutch portion 28 which is connected to the rotor shaft 16 by a substantially radial rotor ring portion 26. The cylindrical clutch portion 28 defines a driven clutch element 29.

The pump 10;10′ comprises a rotatable driving means 30 which is rotatably supported by the rotor shaft 16 by means of two roller bearings 32,33. The rotatable driving means 30 is S-shaped in cross-section, whereby the end of the inner axial leg 34 is supported by one roller bearing 32 at the rotor shaft 16. The inner half of the S-shaped driving means 30 encloses a ringlike magnetic unit 36. The outer half of the S-shaped driving means 30 encloses the cylindrical rotor clutch portion 28 defining the driven clutch element 29.

The two cylindrical portions 38, 40 of the outer half of the S-shaped driving means 30 form two rotatable driving clutch elements 39, 41 which define two cylindrical working gaps 42, 44 between them and the driven clutch element 29, respectfully. The radial outside cylindrical portion 40 of the driving means 30 serves as a pulley wheel 46 which is driven by the transmission belt 12. The radial outside cylindrical portion 40 of the driving means 30 is directly rotatably supported by the second roller bearing 33 at the rotor shaft 16 by means of a radial support ring 65.

The magnetic unit 36 consists of a ringlike electromagnet 50 which is surrounded by a (in cross section) U-shaped ringlike back iron 52 which is open to the radial outside. The cylindrical part of the back iron 52 is formed by a ringlike cylindrical permanent magnet 54 which is axially magnetized so that it is magnetized in parallel and in-line with the toroidal magnetic field 72 generated by the activated electromagnet 50. The back iron 52 and the radial outside cylindrical portion 40 of the driving means 30 are made of ferromagnetic material and define a toroidal path for the magnetic fields 70, 72.

The permanent magnet 54 generates a toroidal magnetic field 70 which penetrates the working gaps 42, 44 radially. When the electromagnet 50 is active, i.e., energized with electric energy, it generates a toroidal magnetic field 72 as well which is parallel to the toroidal magnetic field 70 of the permanent magnet 54 but has an opposite polarity.

The magnetic unit 36 and the clutch elements 29,39,41 define a magneto-rheological coupling 60 whereby the working gaps 42, 44 are filled with a magneto-rheological liquid 62.

When the electromagnet 50 is not active, only the permanent magnet 52 generates a toroidal magnetic field 70 which penetrates the working gaps 42, 44. The viscosity of the magneto-rheological liquid is therefore high, so that the coupling is engaged or connected. When the electromagnet 50 is activated by an external pump control means 80, the toroidal magnetic field 72 of the electromagnet 50 substantially compensates the toroidal magnetic field 70 of the permanent magnet 52 so that the resulting magnetic field in the working gaps 42, 44 is reduced to a minimum. As a consequence, the viscosity of the magneto-rheological liquid significantly increases so that the coupling is more or less disconnected or disengaged.

The pump control means 80 of the coolant pump 10′ activates the electromagnet 50 as long as the engine's temperature is below a limiting value of 70° C., for example.

If the pump control means 80 and/or the electromagnet 50 should fail, the coupling 60 is always automatically in the engaged or connected state. The fluidic pump 10;10′ is consequently failsafe.

The present invention is not limited to embodiments described herein; reference should be had to the appended claims.

What is claimed is:

1-8. (canceled)

9. An automotive fluidic pump comprising:
a driving device;
a pump wheel;
a hydraulic coupling configured as a magneto-rheological coupling comprising a rotatable driving clutch element which is permanently connected to the driving device;
a rotatable driven clutch element permanently connected to the pump wheel;
a magneto-rheological liquid filling a working gap arranged between the rotatable driven clutch element and the rotatable driving clutch element; and
a magnetic unit comprising a permanent magnet and an electromagnet, the permanent magnet and the electromagnet each being configured to magnetically affect the working gap,
wherein,
each of the driving device and the pump wheel are connectable by the hydraulic coupling, and
the electromagnet is arranged to compensate a magnetic field created by the permanent magnet in the working gap when the electromagnet is activated.

10. The automotive fluidic pump as recited in claim 9, wherein the automotive fluidic pump is a coolant pump and the driving device is a pulley wheel driven by an internal combustion engine.

11. The automotive fluidic pump as recited in claim 10, further comprising a pump control device which is configured to activate the electromagnet when a temperature of the internal combustion engine is below a limiting value.

12. The automotive fluidic pump as recited in claim 9, wherein the electromagnet is configured to be non-rotating.

13. The automotive fluidic pump as recited in claim 9, wherein the permanent magnet is configured to be non-rotating.

14. The automotive fluidic pump as recited in claim 9, wherein the permanent magnet is a magnet ring, the electromagnet is a ring coil, and the magnetic field of the permanent magnet is configured to be in-line with a magnetic field of the electromagnet when activated so that the magnetic fields of the activated electromagnet and of the permanent magnet overlap.

15. The automotive fluidic pump as recited in claim 9, wherein at least a part of the working gap is arranged cylindrically.

16. The automotive fluidic pump as recited in claim 15, wherein the permanent magnet and the electromagnet are arranged radially inwardly of the working gap which is arranged cylindrical.
